(19) United States
(12) Patent Application Publication
(10) Pub. No.: US 2010/0320161 A1
(43) Pub. Date: Dec. 23, 2010

(54) Gift support structure

(76) Inventors: Gregory G. Bennett, Lake Park, GA (US); Audrey A. Bennett, Lake Park, GA (US)

Correspondence Address: LANGDALE & VALLOTTON, LLP, 1007 N. PATTERSON STREET, VALDOSTA, GA, 31601, US

(21) Appl. No.: 12/798,643

(22) Filed: Apr. 8, 2010

Related U.S. Application Data
(63) Continuation-in-part of application No. 12/456,523, filed on Jun. 18, 2009.

(51) Int. Cl. A47F 7/00; F16B 2/22; F16M 11/04; F21S 4/00; F21V 9/00

(52) U.S. Cl. 211/49.1; 24/530; 248/121; 362/249.16; 362/249.14; 362/231

(57) ABSTRACT

A structure having a base for supporting vertical struts to display in a generally linear manner Christmas stockings containing gifts thus making each stocking readily identifiable to the gift recipients with improved stability for the structure. This stability is enhanced by angularly offsetting adjoining pairs of the struts relative to each other and with respect to the sides of the base.

This is a continuation-in-part of pending U.S. application Ser. No. 12/456,523 filed by Gregory G. Bennett and Audrey A. Bennett who are the sole inventors of claims 1 through 8, inclusive in the '523 application and claims 1 through 25 in this application, for which applicants also claim the benefit of the '523 application filing date.

### CROSS-REFERENCES TO RELATED APPLICATIONS

U.S. patent application Ser. No. 12/456,523 Filed Jun. 18, 2009

### FEDERALLY SPONSORED RESEARCH OR DEVELOPMENT

None

### NAMES OF PARTNERS TO A JOINT RESEARCH AGREEMENT

None

### REFERENCE TO “SEQUENCE LISTING”

None

### BACKGROUND OF THE INVENTION

This invention is directed to structures for supporting gifts for festive occasions and, more particularly, to a structure for supporting Christmas stockings and associated Christmas decorations on struts that are angularly separated from each other to improve structural stability, and the like.

The delightful practice in which “ . . . stockings were hung by the chimney with care, in hopes that St. Nicolas soon would be there . . . ” is, with the aid of the high-rise apartment dwelling and modern architecture, swiftly passing from the holiday scene. The typical household no longer has a fireplace, an exposed chimney, and a mantel from which Christmas stockings can be hung. Nevertheless, gaily decorated Christmas stockings stuffed with toys, candies and small presents remain an integral part of the Christmas celebration.

In the absence of the fireplace mantel, however, there remains an unsatisfied need to display these stockings in an adequate manner. For example, one proposal suggests the use of a central, vertically mounted connector rod that supports an array of radially protruding arms each of which supports a respective Christmas stocking. This structure makes it necessary for a Christmas gift recipient to search through the array of hanging stockings in order to find a particular stocking.

Unfortunately, the foregoing structure has several flaws. First, in all but the most unusual circumstances the total weights of the gifts in each of the stockings will differ from one another. This causes an imbalance tending to tip the entire display over onto one side. Second, even with generally balanced stocking weights the actions of two or more gift recipients, eager to find their respective stockings, are quite likely to cause the display to fall to one side with possible damage to some of the gifts and, perhaps, to the display structure. For example, by tilting the loaded display structure just slightly to one side, all of the filled stocking will sway toward that same side thereby aggravating and accelerating the heeling action, when once initiated.

Consequently, there is a need for a more stable apparatus that better displays Christmas stockings and the like.

### BRIEF SUMMARY OF THE INVENTION

These and other disadvantages of earlier proposals for dispensing a gifts on festive and other occasions, of which Christmas gifts are typical, are overcome to a great extent through the practice of the invention. For example, by mounting several protruding struts, each for supporting a respective stocking, in a manner that is generally perpendicular to a base the need generally to balance the individual stocking contents' weight is avoided. The stockings, moreover, so mounted each on an individual strut in a generally linear array not only makes each stocking immediately apparent to its recipient, but it also reduces the likelihood for the structure from being destructively tipped over in that the gift recipients do not need to search and probe around and through the structure for their respective stockings. A further advantage of this novel structure is in its adaptability to family size. By varying the length of the base, the number of protruding struts can be increased or decreased to match the number of anticipated gifts and gift recipients.

A salient feature of the invention also is the angular offset or staggering between adjacent struts relative to the sides of the base. So staggered, the struts further inhibit the entire structure from tipping onto a side. Thus, as a full stocking is swayed to one side the other stockings in the array remain unmoved and do not add their respective weights further to unbalance the structure. Even in response to a relatively violent impact any sway that might be imparted to stockings on struts spaced from the point of impact will be of reduced amplitudes thereby making lesser contributions to tipping the structure over on one side.

Further, the base and the protruding struts also offer support for decorative material evocative of the holiday or other festive event.

These and other features of the invention are described in more complete detail in connection with the following description of preferred embodiments of the invention when taken in conjunction with the figures of the drawing. The scope of the invention, however, is limited only through the claims appended hereto.

### BRIEF DESCRIPTION OF THE SEVERAL VIEWS OF THE DRAWING

FIG. 1 is a perspective view of a typical embodiment of the invention;

FIG. 2 is a perspective view in full section of the embodiment of the invention shown in FIG. 1 from which decorative materials have been removed and looking in the direction of the arrows 2-2 in FIG. 4;

FIG. 3 is a detail front elevation of a typical strut for use in connection with the embodiment of the invention shown in FIGS. 1 and 2;

FIG. 4 is a perspective view of the embodiment of the invention shown in FIG. 1 and from which the Christmas stockings have been removed;

FIG. 5 is a perspective view of the base for an embodiment of the invention for four Christmas stockings and from which decorative materials have been removed;

FIG. 6 is a perspective view of the base for an embodiment of the invention for five Christmas stockings and from which decorative materials have been removed;

FIG. 7 is a perspective view of the base for an embodiment of the invention for six Christmas stockings and from which decorative materials have been removed; and

FIG. 8 is a view in partial section of the embodiment of the invention shown in FIG. 1 wherein an alternative technique for connecting a typical strut to the base is illustrated;

FIG. 9 is a portion of the invention in full section that illustrates still another technique for connecting a strut to a base for the gift support structure; and

FIG. 10 is a plan view of a further embodiment of a base for the gift support structure.

### DETAILED DESCRIPTION OF THE PREFERRED EMBODIMENT OF THE INVENTION

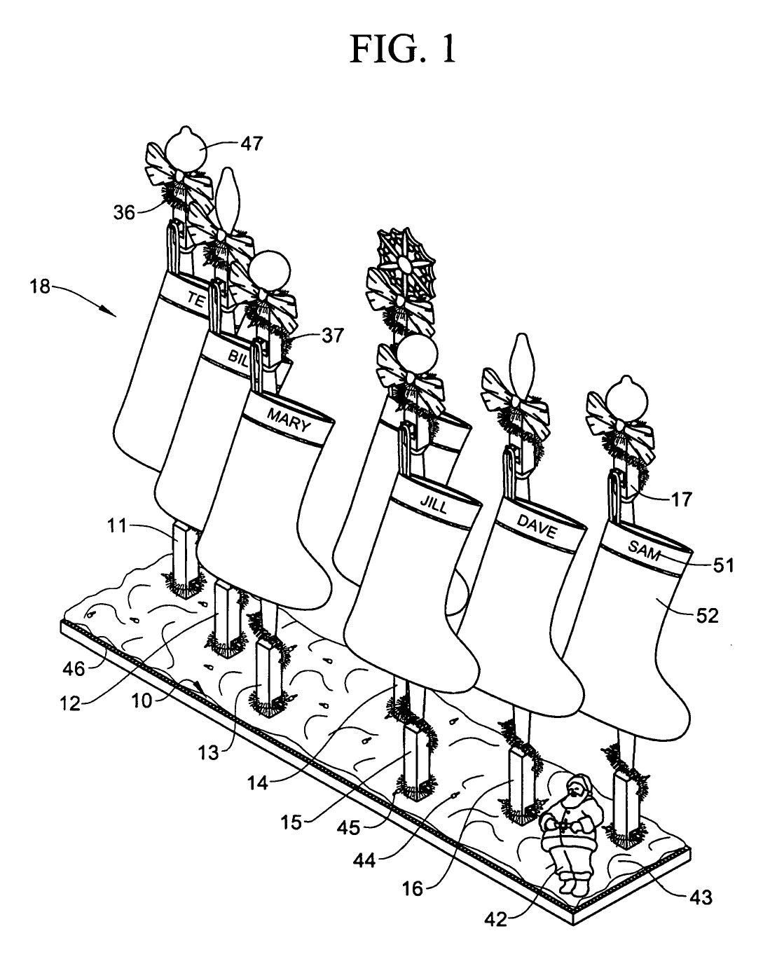

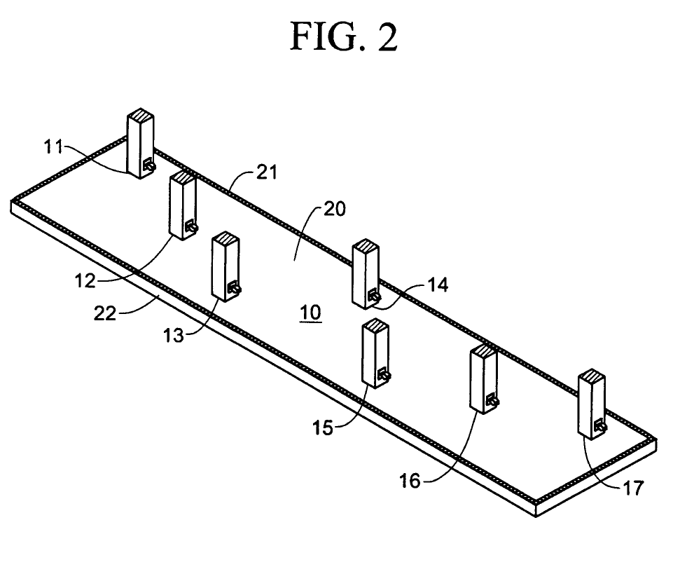

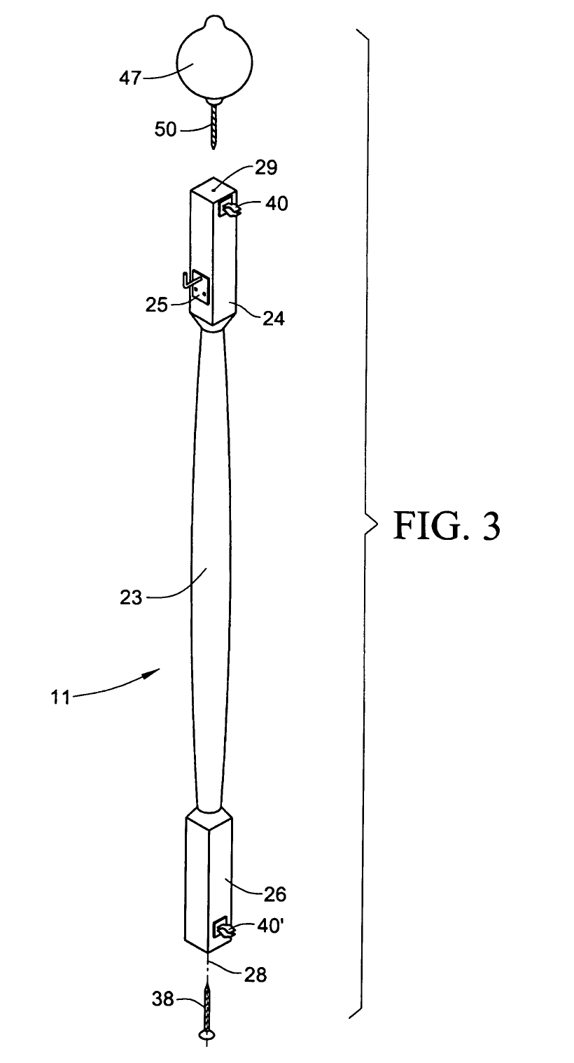

Attention is invited to FIG. 2 which shows a platform or a base 10, illustratively of wood suitable for supporting and displaying seven Christmas stockings (FIG. 1). The base 10 is approximately 50¾ inches in length, 11½ inches in width and 1 inch thick. The base 10 also supports an array of seven protruding struts 11, 12, 13, 14, 15, 16 and 17 only lower portions of which are shown in FIG. 2. Preferably, the struts 11 through 17 are about three feet in length (when measured from the base 10) although the struts 11 through 17 can be of different heights, depending on the desired visual effect. The struts 11 through 17, moreover, are fastened to flat surface 20 of the base 10 by means of countersunk 2½ inch wood screws (of which screw 38 is shown in FIG. 3) that protrude through the flat surface 20 of the base 10 and into the adjoining ends of the respective struts 11 through 17 in order to secure the struts 11 through 17 to the base 10 in a manner generally perpendicular to the plane of the flat surface 20. To accommodate these wood screws, pre-drilled 7/64 inch pilot holes (not shown) are formed in the base 10.

The positions of the struts 11 through 17, in the illustrative embodiment of this detail of the invention shown in FIG. 2, that bear against the flat surface 20 are square, having sides that are between 1¼ inches to 2 inches in length. The adjoining struts in the arrays of struts 11 through 17 are spaced from and angularly offset relative to each other. For example, the strut 12 is spaced diagonally from the strut 11, the angular offset of the diagonal relative to side 21 of the base 10 being about +15°. Continuing along the base 10 from left to right as viewed in FIG. 2 there are the following angular relationships between consecutive pairs of struts:

| Strut Pairs | Angle | |
|---|---|---|
| 12-13 | +15° | |
| 13-14 | −46° | (measured from side 22) |
| 14-15 | +46° | |
| 15-16 | −15° | (measured from side 22) |
| 16-17 | −15° | (measured from side 22) |

The separations between the foregoing adjoining pairs of struts each being about 6 inches as measured parallel with the sides 21 and 22.

As best shown in FIG. 3, the struts 11 through 17, of which the strut 11 is typical, each are formed from three foot long wooden sticks with square cross-sections preferably of 1¼ inch on each side. Central portion 23 (of 14 inches in length) is turned on a lathe or the like to a generally cylindrical configuration. A first portion 24 of the strut 11 retains its square transverse cross-section and has a length of 11 inches. Note in particular that a metal hanger 25 is attached by wood screws, an appropriate glue or other suitable means to one side of the first portion 24 and close to an end of the strut 11. A 2 inch hole 29 that is 3/32 of an inch in diameter is formed in the center of the strut 11 in general alignment with longitudinal axis 28 of the strut 11. A second portion 26 of the strut 11 at the end of the strut 11 that is opposite to the first portion 24 also retains its square cross section. It is, moreover, this second portion that is fastened to the base 10 (FIG. 2) through the countersunk wood screw 38 mentioned above. The placement of the wood screw 38 within the second portion 26 is secured through a 7/64 inch pilot hole (not shown in the Drawing) that is formed coincident with the longitudinal axis 28 of the strut 11 in the second portion 26.

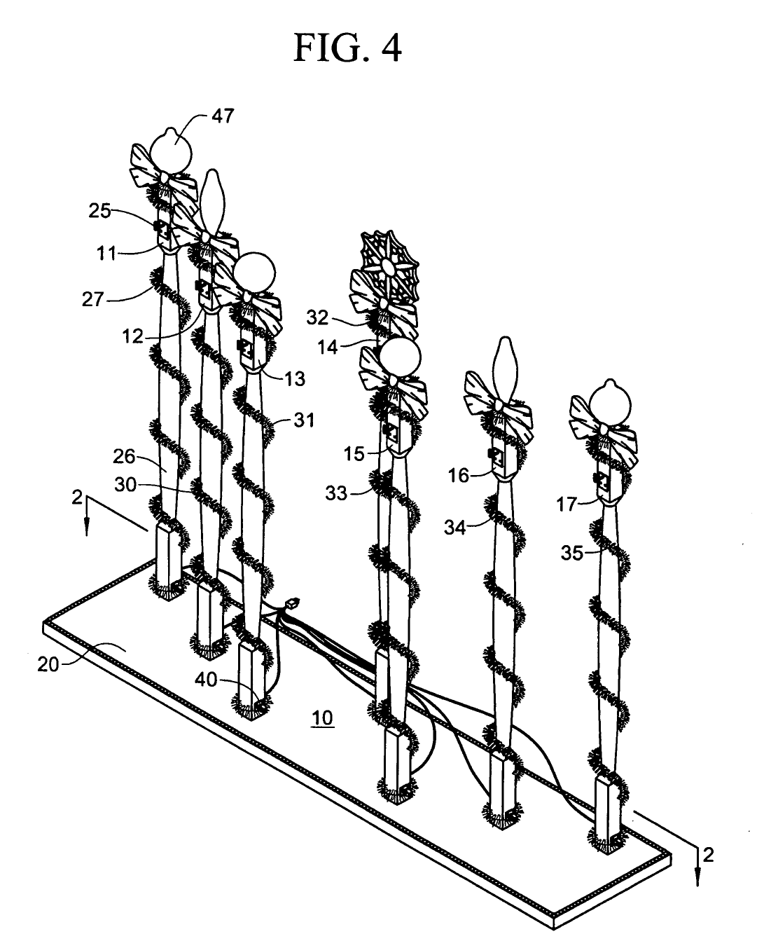

As illustrated in FIG. 4, each of the struts 12 through 17 is secured to the flat surface 20 of the base 10 in the manner previously described in connection with the strut 11.

Each of the struts 11 through 17, moreover, is festooned with a respective one of Charleston fir garlands 27, 30, 31 32, 33, 34, 35 or other decoration appropriate to the occasion. The Charleston fir garlands 27, and 30 through 35 shown in FIG. 4 are made of flame retardant materials that each have an entwined string of electric lights of which lights 36, 37 (FIG. 1) are typical. The lights 36, 37, moreover, preferably are of one or more colors consonant with the holiday or festive event being celebrated. Garlands 27, 30 suitable for the purpose of the invention are identified as Model #M-P70718 and can be purchased from Wal-Mart.

The garlands 27 and 30 through 35 (FIG. 4) are fastened to their respective struts 11 through 17 by means of clips, of which a first clip 40 (FIG. 3) on the strut portion 24 is shown. The garland 27 also is secured to the portion 26 on the strut 11 by means of another associated clip 40′ that presses the other end of the garland 27 to the second portion 26 of the strut 11.

The remaining struts 12 through 17 are each similarly decorated with respective individual garlands 30 through 35.

Turning once more to FIG. 1, the base 10 also can support decorations of which a Santa Claus image 42, artificial snow drifts 43, further lights 44, 45, also, of one or more colors, suggestive of the Christmas season or other festive occasion. A multi-colored cord 46 also is placed around the periphery of the base 10. Each of the struts 11 through 17 is completed by means of Christmas ornament finials, of which finial 47 (FIGS. 1 and 3) is typical. With particular attention to FIG. 3, note that the finial 47 has a 2½ inch stem 50 that protrudes from an end of the finial 47. The stem 50 is received in the 2 inch hole 29 described above with respect to the first portion 24 of the strut 11. Preferably, the stem 50 is either glued within the mating 2 inch hole 29 that is in alignment and coincident with the longitudinal axis 28 of the strut 11 or the stem 50 is flexible, such as a pick stick, flexible stick, plastic covered wire or a plastic stick, to minimize breakage. Six other finials shown in FIG. 1 also are secured to their respective struts 12 through 17 in a manner similar to that described above in connection with the finial 47 and the strut 11.

In operation, each of the Christmas stockings in the array 18 (FIG. 1) is mounted on an individual one of the struts 11 through 17 (FIG. 4) by attaching the stockings each to an individual hanger (of which the hanger 25 shown in FIG. 3 is typical). As best shown in FIG. 1, the structure that characterizes the invention presents each of the stockings in an essentially linear array. As a result, names 51 on each of the stockings in the array 18 are immediately apparent to the proper gift recipients. In this manner the need for the recipients to search in and through the radial presentation of the prior art to find a particular stocking is overcome.

Upon removal of a stocking, tipping the entire structure should be unnecessary. But, if the structure is tipped, the stability to overcome the tipping force is achieved for at least two reasons. First, depending on the direction in which exemplary stocking 52 (FIG. 1) is tipped, the other six stockings will lay up against their respective struts 11 through 16 and will not sway through the full heeling angle applied to the stocking 52. In this manner the consequence of the heeling impact is attenuated as that impact is dissipated among the other six stockings. Second, because each of the struts 11-17 are angularly staggered relative to each other there are restoring moments applied by at least some of the other six stockings distributed across the surface 20 of the base 10 that counterbalance the tipping moment applied to only one of the stockings and its associated strut.

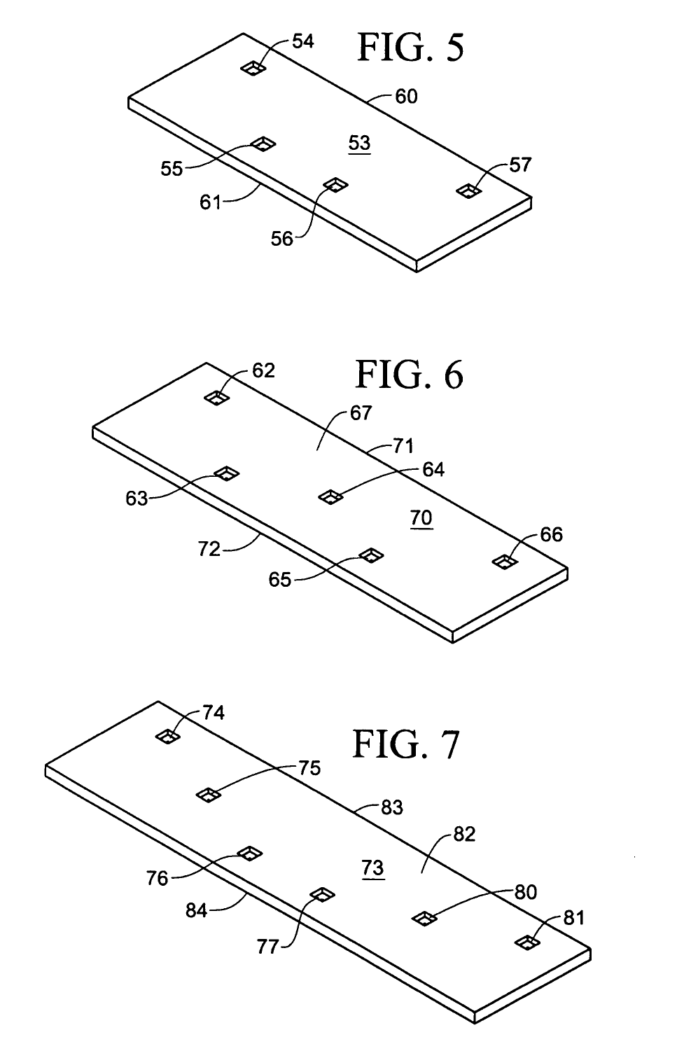

As mentioned above, a special advantage of the invention is its adaptability to different numbers of gift recipients. In this respect, attention is invited to FIG. 5 which illustrates an embodiment of the invention adapted to four gift recipients. A base 53 formed preferably from a wooden plank 29 inches long, 11½ inches wide and 1 inch thick supports four struts 54, 55, 56, 57. The four struts 54-57 in accordance with the invention enjoy the following angular relationship between consecutive pairs of the struts, measured relative to lengthwise side 60 of the base 53 as follows:

| Strut Pairs | Angle | |
|---|---|---|
| 54-55 | 38° | |
| 55-56 | 0° | |
| 56-57 | −38° | (measured from side 61) |

Separation between the struts in each of these pairs measured parallel to the lengthwise sides 60, 61, is about 6 inches. Further with respect to the invention note that it is not necessary for all of the struts in a given array to be staggered relative to each other as shown by the 0° angular separation between the strut pairs 55-56.

A structure suitable for five gifts or gift recipients is shown in FIG. 6 in which struts 62, 63, 64, 65 and 66 are each secured to flat surface 67 for base 70. The five struts 62 through 66 are mounted approximately 6 inches apart from each other, as measured parallel with sides 71 and 72 of the base 70, the base 70 being about 35½ inches in length, 11½ inches in width and 1 inch thick. The angular relationships between adjacent strut pairs, measured relative to the sides 71 and 72 are shown in the following table:

| Strut Pairs | Angle | |
|---|---|---|
| 62-63 | 38° | |
| 63-64 | −28° | (measured from side 72) |
| 64-65 | 28° | |
| 65-66 | −38° | (measured from side 72) |

Attention now is invited to base 73 (FIG. 7), the base 73 being suitable to accommodate six gifts (not shown in FIG. 7) for recipients, these gifts, or stockings being each individually mounted on a respective one of struts 74, 75, 76, 77, 80 and 81 that protrude generally perpendicularly from surface 82 of the base 73. The base 73, for example, is 43½ inches in length, 11½ inches in width and 1 inch in thickness. Further in this regard adjacent pairs of the struts are spaced 6 inches apart when measured parallel to sides 83, 84 of the base 73. Exemplary angular separations of adjacent strut pairs, measured relative to the sides 83, 84 of the base 73 are:

| Strut Pairs | Angle | |
|---|---|---|
| 74-75 | 15° | |
| 75-76 | 15° | |
| 76-77 | 0° | |
| 77-80 | −15° | (measured from side 84) |
| 80-81 | −15° | (measured from side 84) |

Once more attention is invited to the fact that not all of the strut pairs in a given array necessarily need to be angularly staggered relative to each other as indicated by the 0° angular relation between the struts 76 and 77 as shown in FIG. 7.

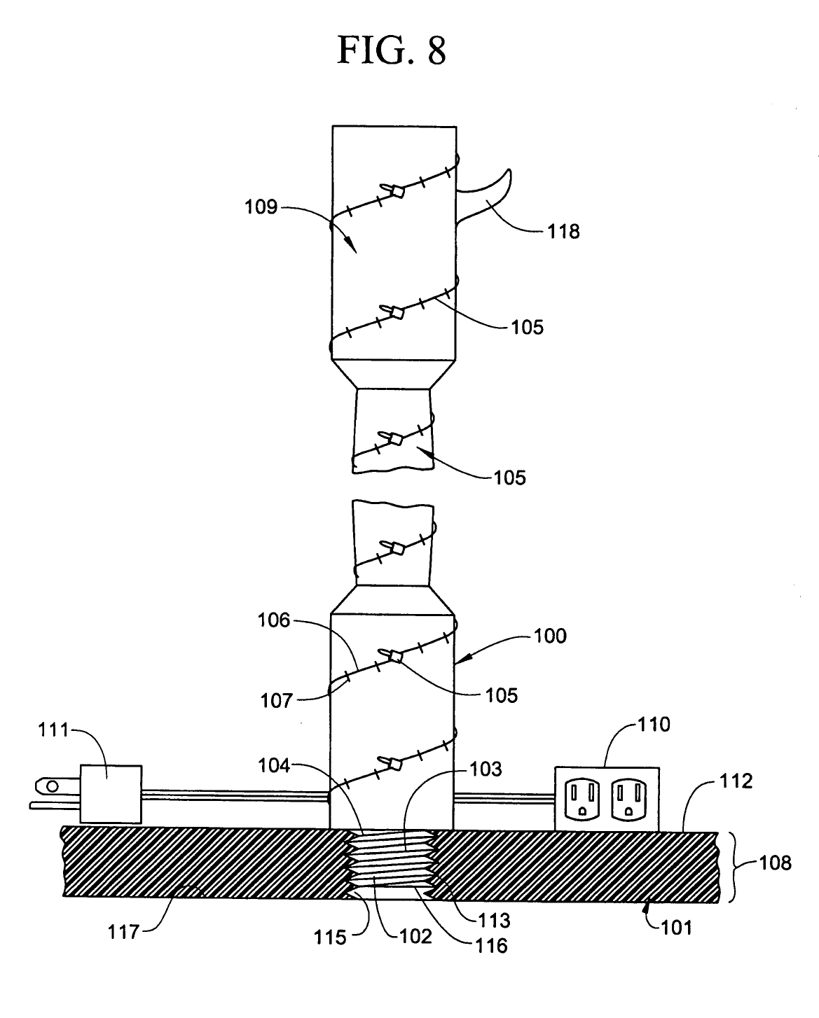

Turning now to FIG. 8, an alternative technique is shown and described for attaching a strut 100 to a base 101. Preferably, both the strut 100 and the base 101 are formed from suitable materials of which wood and plastic (e.g. polyethylene and polystyrene) are typical.

Top 109 of the strut 100 has the further advantage of providing a hanger 118 for supporting gifts such as Christmas stockings (not shown in FIG. 8). Thus, should the strut 100 be formed through plastic molding process or the like it is possible to mold the hanger 118 as an integral element of the strut 100, thereby eliminating several costly manufacturing steps.

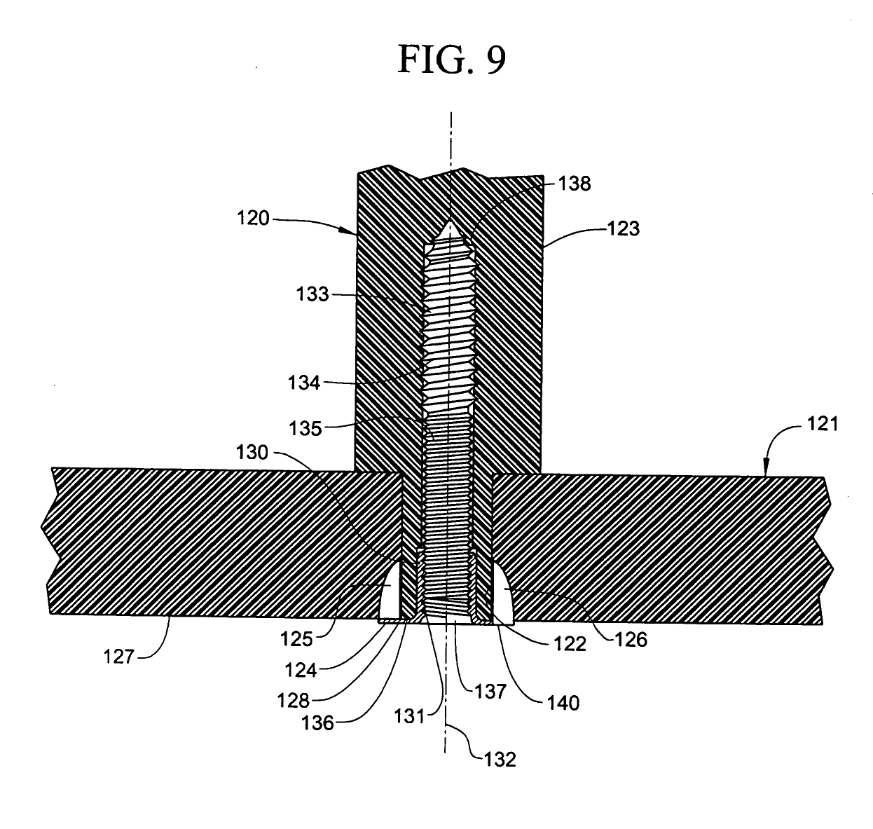

With respect to the strut 100, end 102 is threaded 113 for a length that is slightly less than thickness 108 of the base 101, illustratively, one and one quarter inch long. A string 105 of lights is wound along the balance of the length of the strut 100 above the threaded end 104. As an alternative, the threading 113 can also be provided by the structure shown in FIG. 9, described subsequently in more complete detail. Electrical wiring 106 for the light string 105 is permanently secured to the strut 100 by any suitable means, for example, staples, 107, or two or more clips (not shown in FIG. 8) or other suitable means, preferably molded into the body of the strut 100. For a two clip structure, each clip at respective opposite ends of the string 105 been formed sufficient to support the string 105 even when a garland (also not shown in FIG. 8) is entwined around the string 105. The garlands 27 and 30 through 35 shown in FIG. 4 are not absolute requirements for the practice of the invention. Illustratively (FIG. 8), if preferred the string of lights 105 can be applied to the length of the strut 100 without a garland or as shown in FIG. 4, with a garland.

The winding for the light string 105 is so arranged that ends of the string 105, terminate in a socket 110 and in a plug 111. The socket 110 and the plug 111, moreover both extend from the strut 100 at essentially the same level as upper surface 112 of the base 101.

The base 110 should be about one and one half inches in the thickness 108 and tapped 113 with a thread that mates with the thread 103 on the strut end 102.

To provide a more stable gift support structure and as described above the strut thread 103 is cut along the length (e.g. one and one quarter inches) of the strut end 102 for a suitable length, but a length, that is less than the thickness 108 (e.g. one and one half inches) of the base 101. Thus, a gap 115 of about one quarter of an inch is formed between threaded bottom 116 of the strut 100 and lower surface 117 of the base 101.

In operation, strut 100 provided with the essentially permanently attached light string 105 is threaded into the threading tapped 113 into the base 101 to a depth within the base 101 that establishes the gap 115 between the bottom 116 of the strut 100 and the lower surface 117 of the base 101. Having so joined the strut 100 to the base 101, sufficient slack is provided in the wiring 106 for the light string 105 to enable the plug 111 to be inserted into a mating socket (not shown in FIG. 8). In a similar manner, the socket 110 is coupled to a plug (also not shown in FIG. 8) to establish circuit continuity for the light string 105 with light strings on neighboring struts (also not shown in FIG. 8)

As assembled with the gap 115 between the lower surface 117 of the base and the bottom 116 of the strut 100, the entire structure will rest directly on the base 101 without rocking, or exhibit some further instability that otherwise could occur if one or more strut bottoms 116 protruded from the bottom surface 117 of the base 101.

The preassembled permanent attachment of the light string 105 to the strut 100 provides a further advantage in that the entire support structure can be swiftly assembled and electrically connected with a minimum of effort. Disassembly and storage for the next festive occasion also is facilitated because it is only necessary to disconnect the socket 110 and the plug 111, unscrew the strut 100 and package the disassembled support structure for storage and use at a later time.

Attention now is invited to FIG. 9 which illustrates still another alternative technique for attaching a strut 120 of wood, molded plastic or other suitable material to a base 121, also of wood, plastic and the like. A bore 122 that penetrates the entire thickness of the base 121 is formed in the base, the width of the bore 122 being sufficient to form a snug fit with outer surface 123 of the strut 120.

To join the strut 120 to the base 121 a tee nut 124 has an array of protruding, peripheral prongs 125 and 126 that are pressed through bottom surface 127 and into the base 121 to prevent the nut 124 from turning relative to the base 121 and to join the nut 124 to the base 121. The tee nut 124, moreover, is provided with a centrally disposed nipple 130 with internal threading 131. As illustrated, the nipple 130 protrudes upwardly from a flat plate 128 and is seated inside the bore 122 to be generally coincident with strut and bore axis 132.

A hanger bolt 133 having a coarse thread 134 formed in its upper half has, cut into its lower half, a machine thread 135 that meshes with the internal threading 131 within the nipple 130. As shown in FIG. 9, the coarse thread 134 penetrates strut lower end 136 through a bore 138 that also is coincident with the axis 132. The bore 138 is of a smaller diameter than the corresponding dimension of the coarse thread 134 to enable the coarse thread 134 to engage firmly the strut 120. The machine thread 135 on the hanger bolt 133 is screwed into the nipple 130. Care however, must be taken to assure that gap 137 is established between the lower end of the hanger bolt 133 and exposed bottom surface 140 of the tee nut 124.

By establishing the gap 137 for the strut 120 when mounted on the base 121 as shown in FIG. 9, and for the other strut-and-base combinations (not shown in FIG. 9), the stability of the gift support is improved, the tee nut bottom surface (of which only the bottom surface 140 is shown in FIG. 9) thereby establishing a planar surface for the entire base 121. Further in this connection, the bottom surface 127 of the base 121 can be provided with countersunk holes (not shown in the drawing) that will accommodate the bottom surface 140 of the nut 124, enabling the entire structure to rest firmly on the bottom surface 127 of the base 121.

To disassemble the gift support structure for storage (illustrated in FIG. 8) it is only necessary to disconnect the plugs 111 and sockets 110 and, returning to FIG. 9, to unscrew the strut 120 from its threaded engagement with the coarse thread 134. For assembly, the coarse thread 134 is aligned with the strut and bore axis 132 and the strut 120. The strut 120 either engages the entire coarse thread 134 or contacts the opposing surface of the flat plate 128 on the tee nut 124. Should the bottom surface 127 of the base 121 have a countersunk, recess (not shown in the drawing) for receiving the plate 128, the gift support structure rests directly and firmly on the bottom surface 127 of the base 121.

Other techniques for attaching the struts to the base include, but are not limited to studs with nuts, wedged into the base in the same manner that a polyvinyl chloride (PVC) pipe is pressed into a PVC coupling.

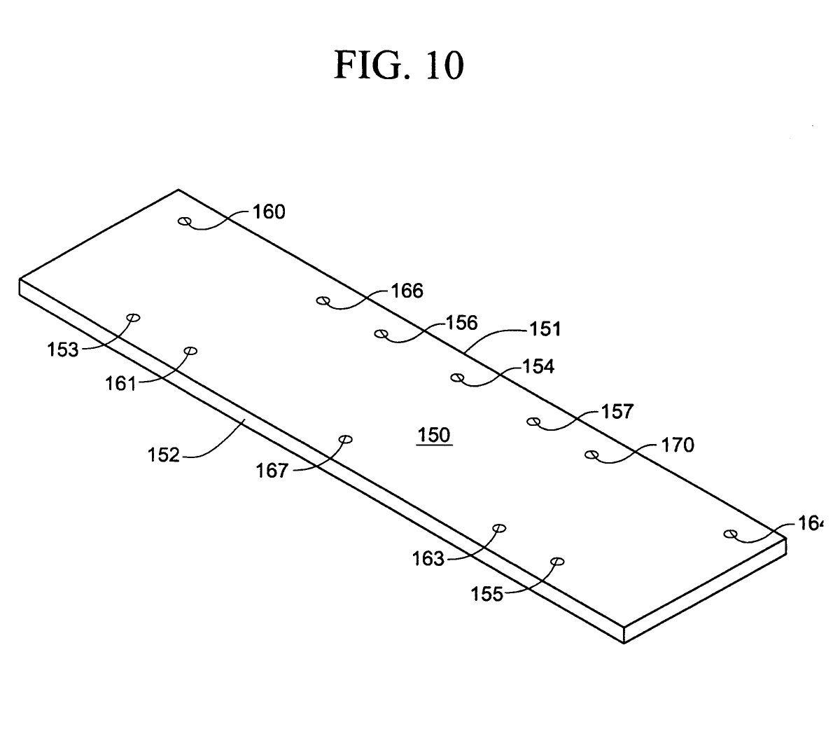

Also in accordance with the features of the invention, base 150 (FIG. 10) has generally parallel sides 151, 152. The function of the base 150 is to enable an array of three to seven struts to be mounted selectively on the base 150 in a staggered configuration in order to accommodate different numbers of gift recipients or quantities of gifts to be distributed and to provide stability for the gift support.

To support three struts, bores 153, 154 and 155 are formed in the base 150, all of the bores being sized to accept a desired means for connecting the strut ends (not shown in FIG. 10) to the base 150. The angles between the bores 153 and 154, as measured from the parallel sides 151, 152, is 24°.

For an array of four struts, the bores 153, 155 and bores 156, 157 are utilized. In this instance the angle between the bores 153 and 156 is 33°, there being no angular relationship between the bores 156 and 157 and an angle of 33° between the bores 157 and 155, as measured relative to the sides 151, 152.

To sustain a group of five struts on the base 150, bores 160, 161, 163, 164 and the bore 154 have been found acceptable and the preferred angular relationships between the associated pairs of these bores is as follows:

| | Angle (measured from the |
|---|---|
| Bore Pairs | sides 151, 152) |
| 160/161 | 30° |
| 161/154 | 30° |
| 154/163 | 30° |
| 163/164 | 30° |

For the purpose of displaying six struts, the following angular disposition has been found suitable:

| | Angle (measured from the |
|---|---|
| Bore Pairs | sides 151, 152) |
| 160/153 | 41° |
| 153/156 | 33° |
| 156/157 | 0° |
| 157/155 | 33° |
| 155/164 | 41° |

And to support seven struts on the base 150, the preferred combination of the bores 160, 153, 155 and bores 166, 167 and 170:

| | Angle (measured from the |
|---|---|
| Bore Pairs | sides 151, 152) |
| 160/153 | 41° |
| 153/166 | 43° |
| 166/167 | 43° |
| 167/170 | 43° |
| 170/155 | 43° |
| 155/164 | 41° |

Thus, it has been found that the foregoing bore pair combinations and their associated angular relations produce a satisfactory compromise between structural stability and aesthetic impact. Naturally, other angular relationships can be adopted without seriously degrading the stability of the support structure, or its appearance.

A particular advantage of the base 150 shown in FIG. 10 is the fact that “One size fits all.” Anywhere from three to seven struts can be supported on the base 150 in response to the number of gift recipients, the number of gifts to be displayed, and the like.

For example several sets of struts and other decorations can be supplied with or made available for the support structure. Each of the sets of struts can be decorated for specific festive occasions, e.g. Thanksgiving, birthdays and the like. Consequently, the same base can be used for a number of festive occasions. Also, the preferred materials from which the base and struts are fashioned include, but are not limited to painted metal, injection molded plastic, wood, PVC, and the like.

Clearly, the structures disclosed in the foregoing detailed description represent a marked improvement over the prior art in that the dispositions of adjacent pairs of the supporting struts relative to sides of the bases on which they are mounted make an accidental heeling over of the gift support onto a floor, a table or other surface unlikely. The essentially linear display of the stockings or gifts borne on the individual struts also makes recipient access easier and safer, again from the structural stabilizing standpoint. The principles of the invention as described herein also are adaptable to any number of strut/base combinations.

What is claimed is:

1. A decorative apparatus for distributing gifts to recipients comprising a base having a side, a plurality of struts separated from each other and mounted on said base generally perpendicular thereto, adjoining pairs of said struts being angularly disposed from each other relative to said base side, and means on each of said struts for supporting at least one of the gifts thereon.

2. An apparatus according to claim 1 further comprising Christmas stockings bearing the gifts, said Christmas stockings being disposed on said respective struts by said support means.

3. An apparatus according to claim 1 wherein in said plurality of struts at least some of adjoining pairs of said struts are angularly spaced from each other within a range of ±15° to ±46° relative to said side.

4. An apparatus according to claim 1 further comprising a plurality of garlands, at least some said garlands being mounted on a respective one of said struts in said plurality thereof, and means on said struts for mounting said garlands thereon.

5. An apparatus according to claim 4 wherein said garland mounting means further comprise resilient clips.

6. An apparatus according to claim 1 further comprising a plurality of finials, each of said finials being mounted on at least some of said struts in said plurality thereof.

7. An apparatus according to claim 4 further comprising electric lights entwined in said plurality of garlands.

8. An apparatus according to claim 7 further comprising decorations mounted on said base.

9. An apparatus according to claim 1 wherein at least one of said struts further comprises a threaded end for mounting said strut on said base.

10. An apparatus according to claim 9 wherein at least one of said struts has a light string wound on said strut and attached to said strut.

11. An apparatus according to claim 10 wherein said light string has a plug at one end of said string and a socket at the other end thereof to selectively establish electrical continuity for the apparatus.

12. An apparatus according to claim 9 wherein said base has a thickness forming a lower surface thereof, said base thickness is greater than said strut threaded end to form a gap between said strut threaded end and said base lower surface.

13. An apparatus according to claim 9 further comprising a hanger formed on at least one of said struts.

14. A strut for a decorative apparatus for distributing gifts to recipients comprising an end of the strut having a thread formed thereon for selective attachment to the decorative apparatus, an electric light string having at least two ends, said string being entwined around the strut and attached thereto, a socket and a plug each coupled to a respective one of said light string ends for establishing electrical continuity with the decorative apparatus, and a hanger formed integrally with the strut for supporting at least one of the gifts therefrom.

15. A decorative apparatus for distributing gifts to recipients comprising a base having a pair of lengthwise sides, a plurality of struts separated from each other and mounted on said base generally perpendicular thereto, said plurality of struts wherein at least some of the adjoining pairs of said struts are angularly spaced from each other within a range of ±15° to ±46° relative to said lengthwise sides, electric light strings each having at least two ends and entwined on a respective one of each of said struts, threading formed on an end of at least some of said struts for attachment to said base, a plug at one end of each of said electric light strings and a socket at the other end thereof for establishing electrical continuity throughout each of said electric light strings and at least one hanger formed integrally on each of said struts for supporting the gifts thereon.

16. An apparatus according to claim 1 wherein the mounting of at least one of said struts further comprises an end on said strut, a bolt having at least two threads formed thereon, one of said threads for selectively engaging said strut end, a nut having means to prevent said nut from turning relative to said base, said nut having a thread for selectively engaging said second said two bolt threads whereby said strut can be mounted and dismounted on said base.

17. An apparatus according to claim 16 wherein said nut further comprises a tee nut.

18. An apparatus according to claim 16 wherein said bolt further comprises a hanger bolt.

19. An apparatus according to claim 3 wherein three of said struts form two pairs of said struts in said plurality thereof, each of said pairs forming angles of about 24° relative to said base side.

20. An apparatus according to claim 3 wherein two pairs of four of said struts in said plurality thereof form angles between each of said struts in said pairs relative to said base side of about 33°.

21. An apparatus according to claim 3 wherein four pairs of five of said struts in said plurality thereof form angles between each of said struts in said pairs of said struts relative to said base side of about 30°.

22. An apparatus according to claim 3 wherein five pairs of six of said struts in said plurality thereof form angles between each of said struts in two of said pairs of struts relative to said base side of about 41°, and form angles between another two of said pairs of struts relative to said base side of about 33°.

23. An apparatus according to claim 3 wherein six pairs of seven of said struts in said plurality thereof form angles between each of said struts relative to said base side in two of said six pairs of said struts about 41°, and form angles between each of said struts in four of said pairs relative to said base side of about 43°.

24. An apparatus according to claim 6 wherein said mounting for finials comprises a flexible mounting.

25. An apparatus according to claim 7 wherein said electric lights comprise at least two colors of said lights.
